(19) United States
(12) Patent Application Publication
(10) Pub. No.: US 2017/0341057 A1
(43) Pub. Date: Nov. 30, 2017

(54) CUSTOM WATER ADSORPTION MATERIAL

(71) Applicant: Donaldson Company, Inc., Minneapolis, MN (US)

(72) Inventors: Yehya A. Elsayed, St. Paul, MN (US); Andrew J. Dallas, Lakeville, MN (US); Jon D. Joriman, Little Canada, MN (US); Dustin Zastera, Hastings, MN (US)

(21) Appl. No.: 15/646,856

(22) Filed: Jul. 11, 2017

Related U.S. Application Data
(62) Division of application No. 13/127,687, filed on Jul. 22, 2011, now abandoned.
(60) Provisional application No. 61/111,207, filed on Nov. 4, 2008.

(51) Int. Cl. B01J 20/28; B01J 20/10; B01J 20/18; B01J 20/20; C01B 32/354

(52) U.S. Cl. CPC B01J 20/28052; B01J 20/20; B01J 20/28033; B01J 20/28011; C01B 32/354; B01J 20/186; B01J 20/103; B01J 2220/42

(57) ABSTRACT

The technology disclosed herein is directed to controlling humidity levels, such as the humidity level in an enclosed environment. The water isotherm of the adsorbent material is customized through the modification of the surface chemistry of the adsorbent. By modifying the surface chemistry of the adsorbent in various ways and to varying degrees, it is possible to customize the adsorbent properties to a range of different humidity levels. Such modification can enhance the adsorbing capacity and efficiency of the adsorbent, especially with regard to low molecular weight water-soluble compounds.

This application is a Divisional of U.S. application Ser. No. 13/127,687, filed Jul. 22, 2011, which is a U.S. National Stage Application under 35 U.S.C. 371 of International Patent Application Serial No. PCT/US2009/063232, filed Nov. 4, 2009, which claims priority to U.S. Patent Application Ser. No. 61/111,207, filed Nov. 4, 2008; the contents of which are herein incorporated by reference.

### FIELD OF THE INVENTION

The current technology relates to adsorbent materials. More particularly the current technology relates to customizable adsorbent materials. Even more particularly, the current technology relates to customizable water adsorption materials.

### BACKGROUND

Various situations require conditions that allow the ability to control the amount of moisture in the air. For example, applications within enclosures that contain sensitive electronic components and equipment often require that moisture levels within the enclosure be maintained and regulated to operate consistently. An improper level of moisture can interfere with mechanical and electrical operations of the components and equipment. In another example, it can be desirable to eliminate contaminant compounds within the enclosed environment that are water soluble, such as inorganic salts. In these situations, removing water can reduce the amount of the contaminant compound freely circulating within the enclosure, thus both controlling the humidity levels as well as removing the water soluble contaminant from circulation.

Regulating humidity levels can be particularly important when important equipment is positioned, or processes occur, in a first environment that has a different relative humidity (RH) than a second environment in communication with the first environment. For example, the interior of a disk drive often has a preferred relative humidity that is different than the relative humidity of the external environment in which the disk drive enclosure is located. Disk drives typically have a breather port within their enclosure, allowing air to enter and exit from the drive, which results in humidity fluctuations within the drive enclosure. Sometimes the external environment has a higher relative humidity than the desired relative humidity within the enclosure, and sometimes the external environment has a lower relative humidity than the desired relative humidity within the enclosure. Also, in some implementations the external environment fluctuates between relative humidity levels that are sometimes above and sometimes below the desired relative humidity within the enclosure. In regard to computer disk drives, too much humidity can lead to corrosion of susceptible components, and too little humidity can lead to static electricity which can damage sensitive electrical components.

Thus, applications where controlling humidity is often desirable include internal hard disk drives discussed above, and other enclosures with sensitive optical surfaces or electronic connections, and electronic control boxes. These applications can find use in automobiles, semiconductor facilities and processing equipment, ostomy bag vents, hearing aids, passive components in HVAC applications, hydraulics, engines, engine vents, and many other applications.

Adsorbents are generally employed to control the level of humidity in scenarios similar to those listed above. Each application, however, has specific requirements depending upon the relative humidity range of the particular application, and thus adsorbents must be chosen that perform properly in each particular relative humidity range. Adsorbents also often occupy a relatively large volume compared to other filtering components, and so increasing the capacity of the adsorbent is often desirable. This is increasingly true as various product assemblies, such as disk drives, get smaller and space is a premium.

Therefore, a need exists for an improved adsorbent material for controlling humidity.

### SUMMARY OF THE INVENTION

The technology disclosed herein is directed to controlling humidity levels, such as the humidity level in an enclosed environment. The technology disclosed herein can also be used to controlling humidity levels in open environments, and internal environments which have limited air exchange with external environments. The water isotherm of the adsorbent material is customized through the modification of the surface chemistry of the adsorbent. By modifying the surface chemistry of the adsorbent in various ways and to varying degrees, it is possible to customize the adsorbent properties to a range of different humidity levels. Such modification can enhance the adsorbing capacity and efficiency of the adsorbent, especially with regard to low molecular weight water-soluble compounds.

The adsorbent is carbon in many embodiments of the invention, in particular activated carbon. However, other adsorbent materials can be used in some implementations of the invention. Surface modifications can generally be made on other porous media, including silica, zeolite, and molecular sieves. Additionally, fine fiber media and nanofiber web media can be modified or modified adsorbents can be incorporated into the media. Melt blown fine fibers, electrospinning, and extruded PTFE media may all be used.

As used herein, surface modification includes, among other approaches, chemical treatment to introduce chemical groups onto the surface of the adsorbent through chemical bonding or impregnation. Such chemical groups can be distinguished by their hydrophilicity, Lewis/Bronsted acid-base properties, and hydration capabilities (capacity and kinetics). An adsorbent carbon material suitable for use in controlling the humidity of an enclosure includes, for example, carbon material having modified surface by acid treatment.

When acid treatment is used to modify the surface of the adsorbent, generally the acid treatment comprises treating an adsorbent material or substrate with a strong acid, often with an aqueous acid solution that is at least 5 percent by weight acid, more typically an aqueous acid solution that is at least 10 percent strong acid by weight. In certain implementations the acid treatment comprises treatment of the substrate in an acid solution that is at least 35 percent acid, and optionally a solution that is at least 70 percent acid. In some embodiments the acid solution comprises from 5 to 85 percent acid, in others the acid solution comprises from 20 to 75 percent acid, and yet others the acid solution comprises from 30 to 60 percent acid. Note that even greater than 85 percent acid can be added, typically by use of acid fumes or vapors.

In some implementations the aqueous acid solution comprises nitric acid, optionally at least 5 percent nitric acid, more typically at least 10 percent nitric acid. In certain implementations the acid solution comprises at least 35 percent nitric acid, and optionally at least 70 percent nitric acid. In some embodiments the acid solution comprises from 5 to 85 percent nitric acid, in others the acid treatment comprises from 20 to 75 percent nitric acid, and in yet others the acid solution comprises from 30 to 60 percent nitric acid.

In some implementations two or more surface modifiers are added to an adsorbent, or two or more adsorbents with different surface modifications are combined together. For example, granular adsorbents, polymers, and/or fibers with different surface chemistry and modifications can be physically mixed together.

The above summary of the present invention is not intended to describe each discussed embodiment of the present invention. This is the purpose of the figures and the detailed description that follows.

### BRIEF DESCRIPTION OF THE DRAWINGS

The invention may be more completely understood and appreciated in consideration of the following detailed description of various embodiments of the invention in connection with the accompanying examples reflected in the drawings.

FIG. 1 is a graph depicting the effect of oxidation on water adsorption/desorption isotherm of carbon materials.

FIG. 2 is a graph depicting the effect of oxidation on water adsorption isotherm of carbon materials treated with nitric acid.

FIG. 3 is a graph depicting the acetone breakthrough curves for activated carbon before and after 70% nitric acid treatment.

FIG. 4 is a graph depicting the effect of impregnation on water isotherm of activated carbon impregnated with either 10% citric acid, 5% potassium carbonate, or 5% sodium sulfate.

FIG. 5 is a graph depicting water isotherms on 70% acid treated activated carbon, activated carbon impregnated with 5% sodium sulfate and a physical mixture of both.

Table 1 is a table depicting the effect of different concentrations of acid on the surface chemistry of an activated carbon.

Table 2 is a table depicting the effect of the different concentration of acids on the surface structural features of activated carbon.

Table 3 is a table depicting the effect of ethanol wash on the surface chemistry of the 10% nitric acid treated carbon.

FIG. 6 is a graph depicting water isotherms cycles on activated carbon modified by a 10% acid treatment.

FIG. 7 is a graph depicting water isotherms on activated carbon modified by treatment with different concentrations of nitric acid.

FIG. 8 is a graph depicting dependence of water adsorption on the pH of the carbon surface.

FIG. 9 is a graph depicting dependence of water adsorption on the amount of acidic groups on the carbon surface.

FIG. 10 is a graph comparing water adsorption of granular and web carbon.

FIG. 11 is a graph depicting water isotherm on variety of medias that cover a range of RH.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

The technology disclosed herein is directed to controlling humidity levels, such as the humidity level in an enclosed environment. The water isotherm of the adsorbent material is customized through the modification of the surface chemistry of the adsorbent. Such modification can enhance the adsorbing capacity and efficiency of the adsorbent, especially with regard to low molecular weight water-soluble compounds. By modifying the surface chemistry of the adsorbent in various ways and to varying degrees, it is possible to customize the adsorbent properties to a range of different humidity levels.

Surface modification includes, among other approaches, chemical treatment to introduce chemical groups into the surface of the adsorbent through chemical bonding or impregnation. The change in the hydrophilicity and surface chemistry of an adsorbent can be accomplished through an acid treatment. Several acids can be used in this process such as, for example, nitric acid, phosphoric acid and sulfuric acid. Additional acids include, for example, citric acid and malonic acid. A single acid or a mixture, and a range of different acid concentrations, can be used in this process to achieve different levels of modifications. The treatment process can be done at static or dynamic conditions. Static conditions include, for example, soaking the adsorbent in an acid solution. Dynamic conditions include, for example, having the adsorbent mixed with the acid under stirring and/or rotary or orbital shaking.

Typically an amount of acid is used that is consistent with a particular mass-to-volume ratio of the adsorbent to the acid. Such mass-to-volume ratio depends on factors such as pore volume of the adsorbents, the origin of the adsorbent, and the bulk density of the adsorbent, for example, although other factors can also be relevant. Suitable volume-to-mass (ml/g) ratios include, for example, from 0.1 to 1, from 1 to 10, and from 10 to 100, in the case of activated carbon. The ratio of volume of acid-to-volume of pores per relative to unit mass of carbon include from 0.01 to 1, from 1 to 10, and from 10 to 100.

When acid treatment is used to modify the surface of the adsorbent, generally the acid treatment comprises treating a substrate with a strong acid, often the acid is in an aqueous solution that is at least 5 percent strong acid by weight of the solution, more typically at least 10 percent strong acid by weight of the solution. In certain implementations the acid comprises at least 35 percent acid by weight of the solution, and optionally at least 70 percent acid by weight of the solution. In some embodiments the acid solution comprises from 5 to 85 percent acid by weight of the solution, in others the acid comprises from 20 to 75 percent acid by weight of the solution, and yet others the acid comprises from 30 to 60 percent acid by weight of the solution.

Treatment time also varies based on a variety of factors that include pore volume of the adsorbents, the origin of the adsorbent, and the bulk density of the adsorbent. The treatment time typically varies from a few minutes up to several days. In some implementations the surface treatment is up to 1 hour, in other implementations the surface treatment is up to 24 hours, and in yet other implementations the surface treatment is greater than 24 hours.

In various embodiments the absorbent can be used immediately after the acid treatment. In other embodiments the adsorbent is washed with water to remove a portion of the acid. In such embodiments 1%-10% by weight of the acid may remain in the adsorbent, and sometimes from 1 to 20% by weight. In some of those embodiments 2%-7% of the acid may remain in the adsorbent. In at least one embodiment, 3%-5% of the acid remains in the adsorbent. The pH of the sample can be controlled by the amount of water used in the wash. In various embodiments the pH of the sample is slightly acidic. In at least one embodiment, the pH of the sample is between 4 and 5, in others the pH is from 3.5 to 6.5; and in yet other implementations the pH is from 3 to 7, while in other implementations the pH is from 2 to 8. Generally the amount of acidic groups will range from 0.1 to 10 mmol acidic groups per gram of carbon. In some implementations the amount of acidic groups will range from 1.0 to 10 mmol acidic groups per gram of carbon; in others from 1.0 to 5.0 mmol acidic groups per gram of carbon.

In addition to the use of acids to modify the surface of the adsorbent, other compounds can be used. For example, oxidants such as hydrogen peroxide, oxygen gas, acid vapors, potassium permanganate, potassium dichromate, or ozone, can be used to modify the surface either separately, or in combination with, the acids. Typically these oxidants are added at levels sufficient to impact the water isotherm of the adsorbent. In most implementations the isotherm will show at least a 2 percent change in water pickup at one or more points along the isotherm compared to untreated adsorbent, in others 5 percent change in water pickup, and in yet others it will show at least a 10 percent change in water pickup at one or more points along the isotherm, and in yet other implementations it will show at least 20 percent change at one or more points along the isotherm compared to non-treated adsorbent, commonly greater than 300 percent change, and in some implementations up to 300 percent change.

The surface of the adsorbent material can also be impregnated with components having varying hydration capabilities at different relative humidity. This includes, for example, anhydrous sodium sulfate, citric acid, potassium carbonate, mellitic acid and/or mixtures thereof. Adsorbent properties are customizable for a range of relative humidity with improvement in the overall adsorbent capacity. Impregnation can vary between 0.01-99.9 percent by weight of the adsorbent. However, more typically impregnation will comprise between 1 and 80 percent by weight of the adsorbent, more typically between 1 and 50 percent by weight of the adsorbent, optionally from 1 to 30 percent by weight of the adsorbent. In some implementations the impregnation will comprise between 1 and 10 percent by weight of the adsorbent.

Combining different surface modification methods to control humidity at different selected relative humidity ranges will also result in customized water pickup. By mixing or by impregnation of the oxidized surface of the adsorbent material with various materials, adsorbent capacity can be improved in some situations, and the adsorbent can be customized. Example materials include: sodium sulfate anhydrous, citric acid, potassium carbonate, mellitic acid and/or a mixture thereof. Impregnation can vary between 0.01-99.9 percent by weight, and mixing ratios can vary from 0 to 100% by weight. Impregnation can vary between 0.01-99.9 percent by weight of the adsorbent. However, more typically impregnation will comprise between 1 and 80 percent by weight of the adsorbent, more typically between 1 and 50 percent by weight of the adsorbent, optionally from 1 to 30 percent by weight of the adsorbent. In some implementations the impregnation will comprise between 1 and 10 percent by weight of the adsorbent.

### Examples

The following examples demonstrate various aspects of the present invention. Water isotherms for the examples were measured on a VTI thermogravimetric analyzer with dew point analyzer. Samples typically weighed between 10 and 20 mg, preferably 15 mg. They were dried by heating in dry air (dp<−30 C) at 80° C. The samples were then subjected to humidity ranging from 5-95% rh in 5% rh steps, both adsorption and desorption. Advancement to the next humidity step was controlled by the following equilibrium criteria: <0.001%/min weight change rate or 3 hours since the last step, whichever was first.

The amount of oxygenated surface groups was determined using Boehm titrations methodology: One gram of a carbon sample was placed in 50 ml of the following 0.05 N solutions: sodium hydroxide, sodium carbonate, sodium bicarbonate and hydrochloric acid. The vials were sealed and shaken for 24 h, filtrated and then 10 ml of each filtrate was pipetted and the excess of base or acid left in the solution was titrated with HCl or NaOH, depending on the original titrant used. The amount of acidic sites of various types was calculated under the assumption that sodium hydroxide neutralizes carboxylic, phenolic, and lactonic groups; sodium carbonate neutralizes carboxylic and lactonic; and sodium bicarbonate neutralizes only carboxylic groups. The number of surface basic sites was calculated from the amount of hydrochloric acid that reacted with the carbon.

The pH of carbon samples in suspension provides information about the acidity and alkalinity of the surface. A sample of 0.4 g of dry carbon powder was added to 20 ml of water and the suspension was stirred overnight to reach equilibrium. Then the sample was filtered and the pH of solution was measured.

Nitrogen isotherms were measured using an ASAP 2020 (Micromeritics) at 77 K. Before the experiment the samples were heated at 393 K and then outgassed at this temperature under a vacuum of 10⁻⁵ torr to constant pressure. The isotherms were used to calculate the specific surface area, SBFT, micropore volume smaller than 10 Å, V_{<10 Å}, micropore volume, V_{mic}, and total pore volume, Vₜ. All of these parameters were calculated using Density Functional Theory (DFT).

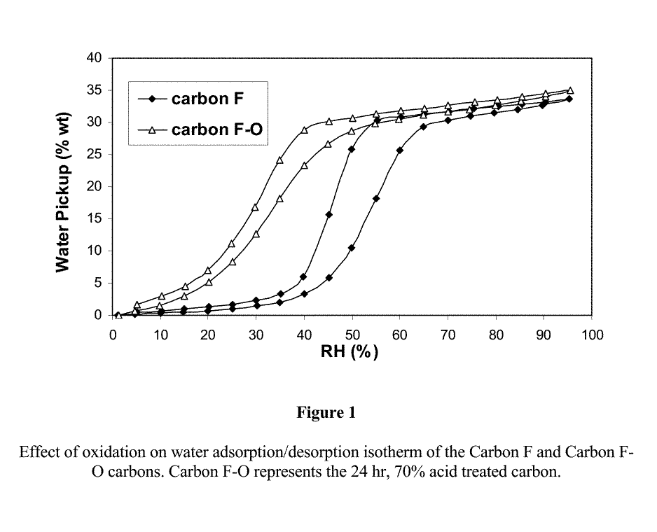

With regard to the specific examples, FIG. 1 demonstrates effects of surface oxidation on water adsorption capacity and kinetics for “carbon F”. Eighty grams of an activated carbon adsorbent in powder form was mixed with 100 ml of 70 percent nitric acid followed by stirring for 26 hours. After treatment, the acid was drained and the carbon sample was washed with water twice to remove a portion of the acid. Such treatment at least partially oxidized the surface of the adsorbent and increased water adsorption at a lower relative humidity. FIG. 1 shows “carbon F”, which is the non-oxidation treated carbon, and “carbon F-O”, which is the oxidation treated carbon. As is evident from FIG. 1, nitric acid treatment of activated carbon F shifted the water isotherm to lower humidity levels, indicating higher hydrophilic characteristic of the oxidized surface.

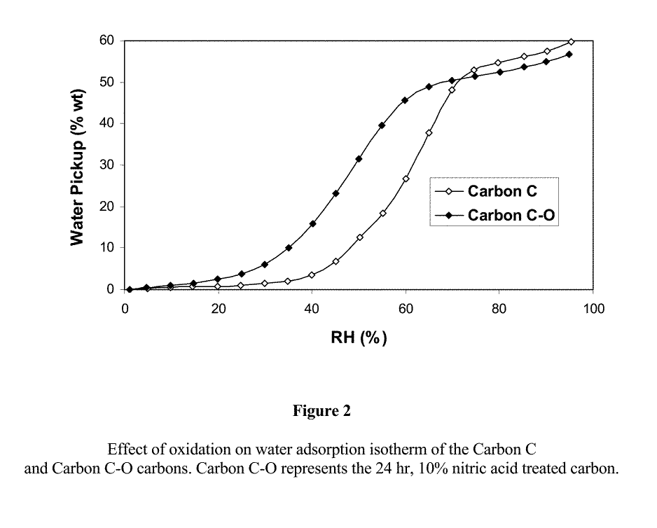

FIG. 2 demonstrates effects of nitric acid treatment of granular “carbon C” on the water adsorption isotherm of the carbon. A similar trend is observed in FIG. 2 as the one observed in FIG. 1. Six grams of carbon C were mixed with 8 ml of 70 percent nitric acid for five minutes in a beaker, then covered with a glass watch for additional 25 minutes. The modified adsorbent sample was then twice washed with 25 ml of distilled water. Afterwards, the sample was placed in an oven to dry at 110° C. for 72 hours, and then the sample was placed in oven at 70° C. until tested. As is indicated in FIG. 2, “carbon C”, which was not treated with nitric acid, had a water adsorption isotherm demonstrating lower hydrophilic characteristics than that of the “carbon C-O”, which had been treated with the nitric acid.

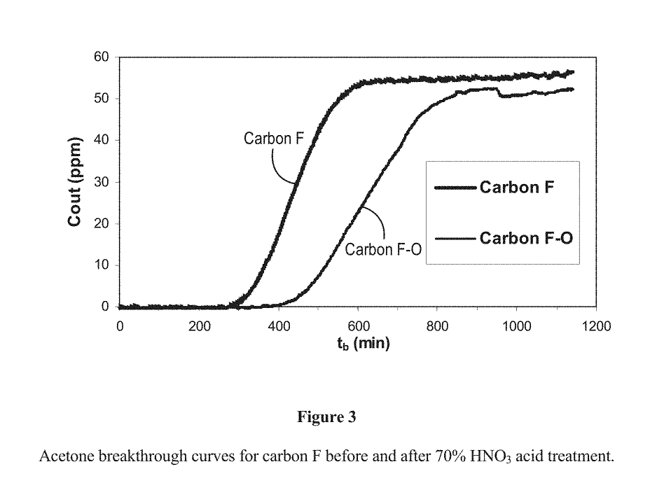

FIG. 3 demonstrates the effect of surface modification of carbon F shown in FIG. 1 on its capacity for acetone. Surface treatment increased the 10% breakthrough time of carbon F for acetone from 340 minutes to about 480 minutes indicating an increase of about 41% capacity at 10% breakthrough concentration. The experimental conditions were as follows: 50 ppm acetone, 30 liters per minute flow rate, 50% RH and 25 C temperature. The carbon dimensions in the cylindrical packed bed were 1 inch depth and 1.5 inch diameter. The carbon mesh size was 12×20. The samples were conditioned at 50% RH prior to the test start. Thus, FIG. 3 demonstrates that the oxidized activated carbon adsorbs more organic compound acetone compared to the non-oxidized activated carbon.

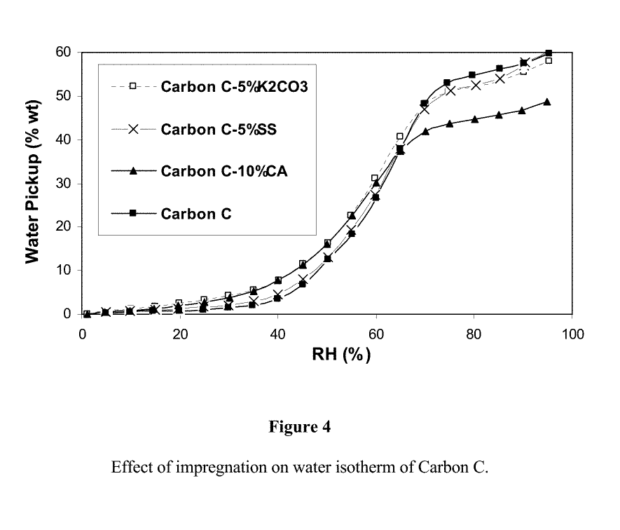

FIG. 4 demonstrates effects of activated carbon impregnation with sodium sulfate (5%), citric acid (10%), or potassium carbonate (5%) on water adsorption. Impregnation enhanced water adsorption in the 40-60% RH range mainly in case of potassium carbonate and citric acid impregnation. Carbon C-5% SS was treated with 5 percent sodium sulfate, Carbon C-10% CA was treated with 10 percent citric acid, and Carbon C-5% K₂CO₃ was treated with 5 percent potassium carbonate.

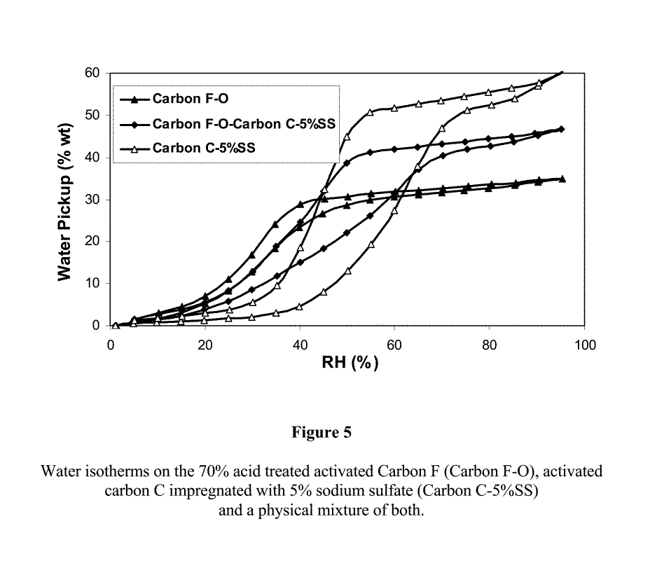

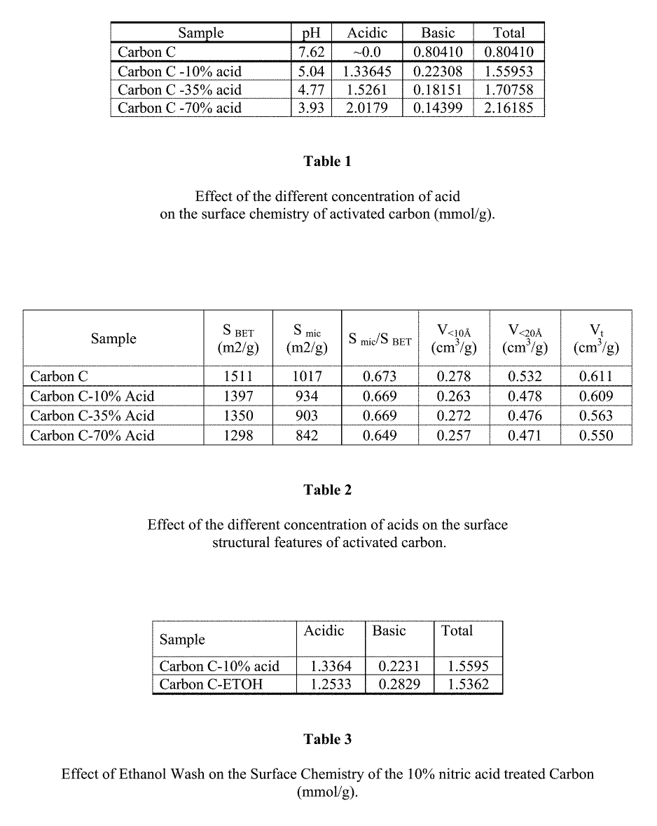

FIG. 5 demonstrates effects of the combination between the oxidized activated carbon impregnated with sodium sulfate (5%) on the water adsorption. Water isotherms on the 70% acid treated activated Carbon F (Carbon F-O), activated carbon C impregnated with 5% sodium sulfate (Carbon C-5% SS) and a physical mixture of both are shown.

The physical combination provided an averaged effect on the performance, in that the water adsorption of the mixture is at least partially between the water isotherms of the individual adsorbents.

Table 1 presents the effect of the nitric acid concentrations treatment on the surface chemistry of carbon. Surface chemistry was analyzed using Boehm titrations where the amounts of acidic and basic groups on the surface were calculated. The surface is believed to become more hydrophilic due to the large increase in the amount of surface groups. The amount of acidic groups for all treatments has increased by more than 1 mmol/g of carbon.

Table 2 presents the effect of nitric acid treatment concentrations on the porous structure of activated carbon. The structural features are not significantly affected by the 10-70% acid treatment. The structural parameters such as surface area (S_{BET}), micropore area (S_{mic}), the volume of pores smaller than 10 Å (V_{<10 Å}), micropore volume (V_{mic}), the total pore volume (Vₜ) and the mean pore diameter (L) were calculated from the nitrogen isotherms for all activated carbons.

Table 3 presents the effect of ethanol wash on the surface chemistry of the 10% nitric acid treated carbon. The surface chemistry of the 10% nitric acid treated activated carbon remained almost intact by the ethanol wash which indicate the stability of the surface chemistry under several manufacturing processes.

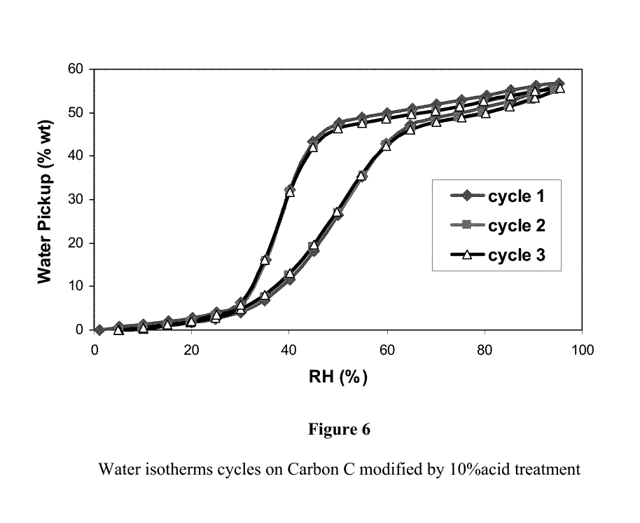

FIG. 6 shows three water adsorption/desorption isotherm cycles on carbon C modified by 10% nitric acid treatment for 24 hrs. No change in the adsorption/desorption behavior were noticed over 3 cycles indicating the stability of the modified carbon and its regeneration capability.

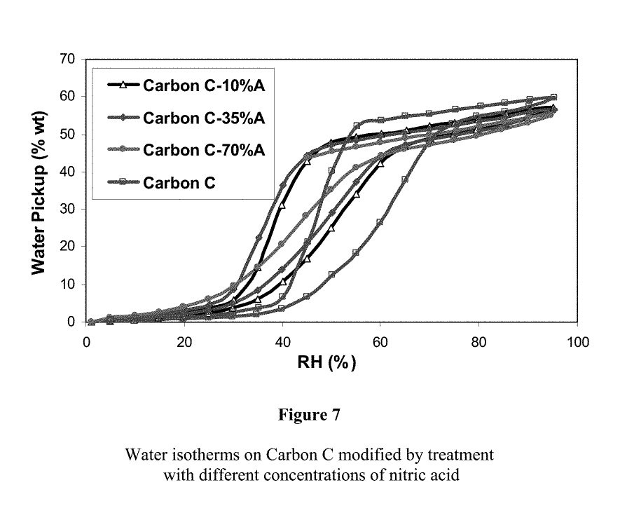

FIG. 7 depicts the water isotherms on carbon C modified by treatment with different concentrations of nitric acid. As depicted in FIG. 7, as the concentration of nitric acid used in the treatment increased, the whole water isotherm shifted to higher water adsorption, particularly at an RH below 70%. In various experimental treatments, the greatest enhancement in the water adsorption of activated carbon was a result of treatment with nitric acid.

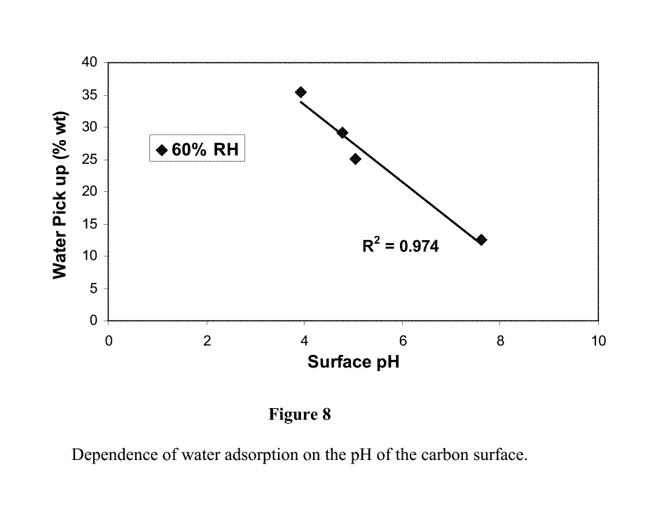

FIG. 8 depicts the dependence of the water adsorption on the pH of the activated carbon surface, which was varied by varying the concentration of the acid during the treatment. Based on this figure, that water adsorption at an RH at 60% increases as the surface pH of the activated carbons decreases.

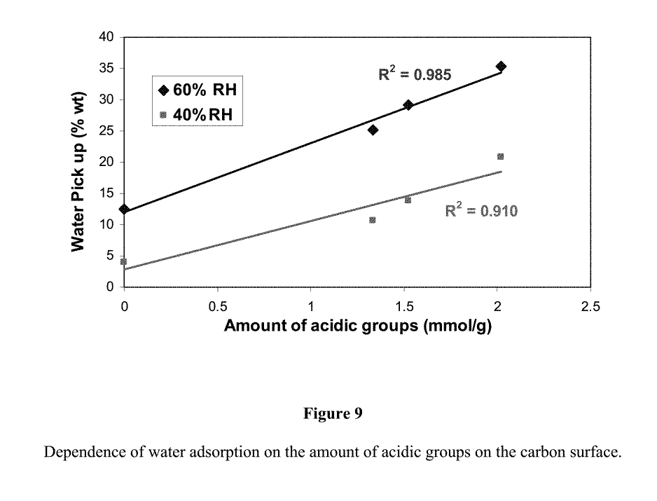

FIG. 9 depicts the dependence of the water adsorption on the amount of acidic groups on the activated carbon surface, which was varied by varying the concentration of the acid during the treatment. Based on this figure, that water adsorption at an RH below at 60% or an RH at 40% increases as the amount of acidic groups on the surface of activated carbons increases.

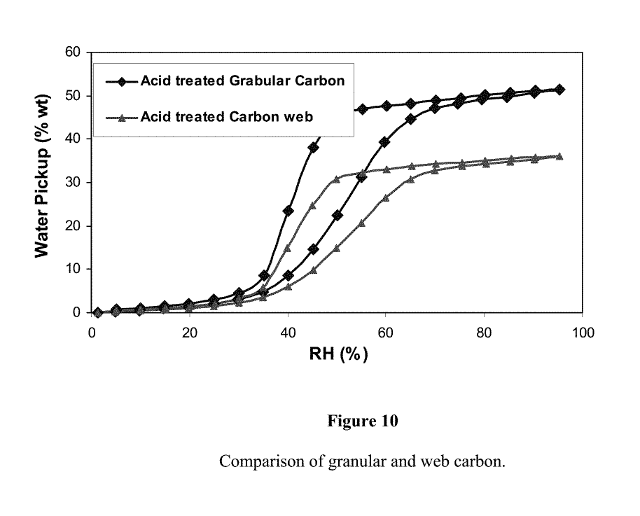

FIG. 10 shows a comparison of granular and web carbon. The acid treated granular curve shows the water isotherms on the acid treated carbon where we see high water pick up in the 40-60% RH range. The acid treated carbon curve represents the water isotherm for the same acid washed carbon but in the web form knowing that about 20% of the web weight is not carbon. The carbon loses about 10% of its capacity as well in the web process. That explains the 30% water reduction by wt. for the web compared to the performance of the granular acid washed carbon. The web material is optionally a composite of PTFE and a granular adsorbent material. The composite can be formed by extruding together an adsorbent material and a PTFE emulsion. The extruded material is then mechanically shaped into its final form as a sheet or tablet.

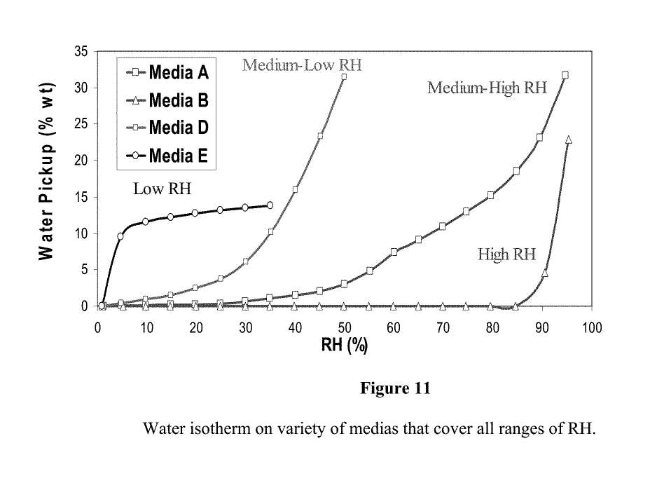

FIG. 11 shows the capability to remove water efficiently at all ranges of RH by using different materials with different surface chemistries. By physically mixing these materials it is possible to customize the water removal as shown in FIG. 5.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

It will be appreciated that, although the implementation of the invention described above is directed to a hard drive enclosure, the present device may be used with other electronic enclosures, and is not limited to hard drive enclosures. In addition, while the present invention has been described with reference to several particular implementations, those skilled in the art will recognize that many changes may be made hereto without departing from the spirit and scope of the present invention.

1.-24. (canceled)

25. A material suitable for use in controlling humidity, the material comprising:
a first adsorbent material, the first adsorbent material having received a first treatment on at least the surface of the first adsorbent material, the treatment providing modified water absorbency properties to the adsorbent; and
a second adsorbent material, the second adsorbent material having received a second treatment on at least the surface of the first adsorbent material, the treatment providing modified water absorbency properties to the second adsorbent.

26. The modified adsorbent material of claim 25, wherein the first and second adsorbent material are arranged in a layered arrangement.

27. The modified adsorbent material of claim 25, wherein the first and second adsorbent material are in a mixed arrangement.

28. The modified adsorbent material of claim 25, wherein at least one of the first and the second adsorbent comprises activated carbon.

29. The modified adsorbent material of claim 25, wherein at least the first or second adsorbent is selected from the group comprising carbon, silica, molecular sieves, zeolites, and combinations thereof.

30. The modified adsorbent material of claim 25, wherein at least one treatment comprises acid treatment.

31. The modified adsorbent material of claim 25, wherein at least one treatment comprises treatment with molecular oxygen, ozone, or combinations thereof.

32. The modified adsorbent material of claim 25, wherein at least one treatment comprises treatment of the adsorbent with hydrogen peroxide, potassium permanganate, potassium dichromate, and combinations thereof.

33. The modified adsorbent material of claim 25, wherein the adsorbent material comprises a web.

34. The modified adsorbent material of claim 25, wherein the web is formed from meltblown fibers, electrospun fibers, extruded PTFE, or a combination thereof.

35-39. (canceled)

40. A method of customizing an adsorbent material comprising:
modifying a surface chemistry of a first adsorbent material to improve moisture adsorption in a first relative humidity range;
modifying a surface chemistry of a second adsorbent material to improve moisture adsorption in a second relative humidity range; and
mixing the modified first adsorbent material and the modified second adsorbent material.

41. The method of claim 40, wherein at least one of the first adsorbent material and the second adsorbent material comprises activated carbon.

42. The method of claim 40, wherein at least one of the first adsorbent material and the second adsorbent material is selected from the group consisting of: carbon, silica, molecular sieves, zeolites, and combinations thereof.

43. The method of claim 40, wherein modifying the surface chemistry of the first adsorbent material comprises administering an acid treatment.

44. The method of claim 40, wherein modifying the surface chemistry of at least one of the first adsorbent material and the second adsorbent material comprises treating the material with molecular oxygen, ozone, or combinations thereof.

45. The method of claim 40, wherein modifying the surface chemistry of at least one of the first adsorbent material and the second adsorbent material comprises treatment of the adsorbent with hydrogen peroxide, potassium permanganate, potassium dichromate, and combinations thereof.

46. The method of claim 40, wherein at least one of the first adsorbent material and the second adsorbent material comprises a carbon web.

47. The method of claim 40, wherein the web is formed from meltblown fibers, electrospun fibers, extruded PTFE, or a combination thereof.

48. The method of claim 40, wherein at least one of the first adsorbent material and the second adsorbent material comprises granular carbon.

49. The method of claim 40, wherein modifying the surface chemistry of at least one of the first adsorbent material and the second adsorbent material comprises impregnating the adsorbent material with an acid.
